(19) United States
(12) Patent Application Publication
(10) Pub. No.: US 2025/0116866 A1
(43) Pub. Date: Apr. 10, 2025

(54) LAYERED KALEIDO GEOMETRIC WAVEGUIDE

(71) Applicant: Meta Platforms Technologies, LLC, Menlo Park, CA (US)

(72) Inventors: Jianbo Zhao, Bothell, WA (US); Pei Xiong, Redmond, WA (US); Yu Shi, Redmond, WA (US); Miaomiao Xu, Redmond, WA (US); Babak Amirsolaimani, Redmond, WA (US)

(21) Appl. No.: 18/768,711

(22) Filed: Jul. 10, 2024

Related U.S. Application Data
(60) Provisional application No. 63/588,856, filed on Oct. 9, 2023.

(51) Int. Cl. G02B 27/01; G02B 6/42; G06F 1/16

(52) U.S. Cl. CPC G02B 27/0172; G02B 6/4214; G06F 1/163; G02B 2027/0123; G02B 2027/0178; G02B 2027/0194

(57) ABSTRACT

A waveguide for a display system includes a waveguide body extending from an input end to an output end and configured to guide light by total internal reflection from the input end to the output end, a first array of partial reflectors disposed within a first strata of the waveguide body, and a second array of partial reflectors disposed within a second strata of the waveguide body overlying the first strata.

### CROSS-REFERENCE TO RELATED APPLICATION

This application claims the benefit of priority under 35 U.S.C. § 119 (e) of U.S. Provisional Application No. 63/588,856, filed Oct. 9, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 shows the structure of an example geometric waveguide and corresponding field-of-view intensity maps at 9 eye pupils within the eyebox region according to some embodiments.

FIG. 2 illustrates the incorporation of a mixing element into a geometric waveguide according to certain embodiments.

FIG. 3 illustrates the impact of co-integrating a mixing element within a geometric waveguide according to some embodiments.

FIG. 4 shows the structure of a geometric waveguide having a mixing element (x-y plane) co-integrated within the folding zone of the waveguide, and corresponding field-of-view intensity maps at 9 pupil locations according to some embodiments.

FIG. 5 illustrates the arrangement of horizontal (x-z plane) and vertical (x-y plane) mixing elements within a geometric waveguide, as well as a corresponding field-of-view intensity map at the central eye pupil according to certain embodiments.

FIG. 6 illustrates the configuration of a geometric waveguide having both a horizontal (x-z plane) mixing element and a vertical (x-y plane) mixing element, as well as corresponding field-of-view intensity maps at 9 eye pupil locations within the eyebox region for the waveguide according to some embodiments.

FIG. 7 illustrates the configuration of a geometric waveguide including a pair of horizontal (x-z plane) mixing elements and a single vertical (x-y plane) mixing element, as well as corresponding field-of-view intensity maps at 9 eye pupil locations according to some embodiments.

FIG. 8 is a cross-sectional schematic view of a layered geometric waveguide according to various embodiments.

FIG. 9 illustrates an example method of manufacturing a layered geometric waveguide according to some embodiments.

FIG. 10 illustrates a further example method of manufacturing a layered geometric waveguide according to certain embodiments.

FIG. 11 is an illustration of exemplary augmented-reality glasses that may be used in connection with embodiments of this disclosure.

FIG. 12 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality (VR) and augmented reality (AR) eyewear devices and headsets may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. The microdisplay is configured to provide an image to be viewed either directly or indirectly using, for example, a micro OLED display or by illuminating a liquid-crystal based display such as a liquid crystal on silicon (LCoS) microdisplay.

Display light may be projected to the eyes of a user using a waveguide display system where the light is in-coupled into the waveguide, transported therethrough by total internal reflection (TIR), and out-coupled when reaching the position of a viewer's eye. The imaging optics may include input-coupling and output-coupling elements such as surface relief gratings/mirrors that are configured to couple light into and out of the waveguide. A vertical grating/mirror coupler, for instance, may be configured to change an out-of-plane wave-vector direction of light to an in-plane waveguide direction, or vice versa, and accordingly direct the passage of light through the waveguide.

The waveguide optics may be advantageously configured to create illuminance uniformity and a wide field of view (FOV). The FOV relates to the angular range of an image observable by a user, whereas illuminance uniformity may include both the uniformity of image light over an expanded exit pupil (exit pupil uniformity) and the uniformity of image light over the FOV (angular uniformity). As will be appreciated, an input-coupling grating may determine the angular uniformity and coupling efficiency of image light. Moreover, the field of view of an augmented reality waveguide may be strongly dependent on the refractive index of the waveguide medium itself and its geometry.

In exemplary systems, light may be presented to a user through pupil expansion using waveguide propagation and pupil replication. Image light can be manipulated to provide virtual object distance matching to a real-world scene with good image clarity along an adequate field of view (FOV) in systems having a commercially relevant and compact form factor.

Achieving suitable pupil replication density and image fidelity in a projected image may face challenges, however, including the appearance of optical artifacts that may result from waveguide displays that are designed to present a large field of view. In some systems, a pupil replication issue can manifest as stripes in the intensity field-of-view maps at different eye pupil locations within the eyebox region, which may adversely affect the user experience. Notwithstanding recent developments, it would be advantageous to provide a waveguide display for generating high quality, large field of view imagery to support a quality immersive experience.

In accordance with various embodiments, a waveguide display includes one or more optical mixing elements located within the waveguide. The optical mixing elements may include transflective components such as partially reflective mirrors that are configured to split an incident light beam and increase the density of light propagating through the waveguide. The optical mixing elements may be extended throughout the waveguide, for example, and may be configured to split a given light beam multiple times, which may improve pupil replication density and image uniformity.

A geometric waveguide may include plural optical mixing elements that are located along the optical path of light that travels within the waveguide. In systems using a single optical mixing element, the mixing element may be characterized as a 50:50 mirror that is configured to reflect 50% of incident light and transmit 50% of incident light. In systems using plural optical mixing elements, on the other hand, one or more of the optical mixing elements may be configured to reflect less than 50% of the incident light and transmit greater than 50% of the incident light, e.g., using one or more 30:70 mirrors. In particular embodiments, the orientation of the optical mixing elements may be configured to particularly address the unwanted generation of image artifacts, including stripes that may arise from regions of low luminescence.

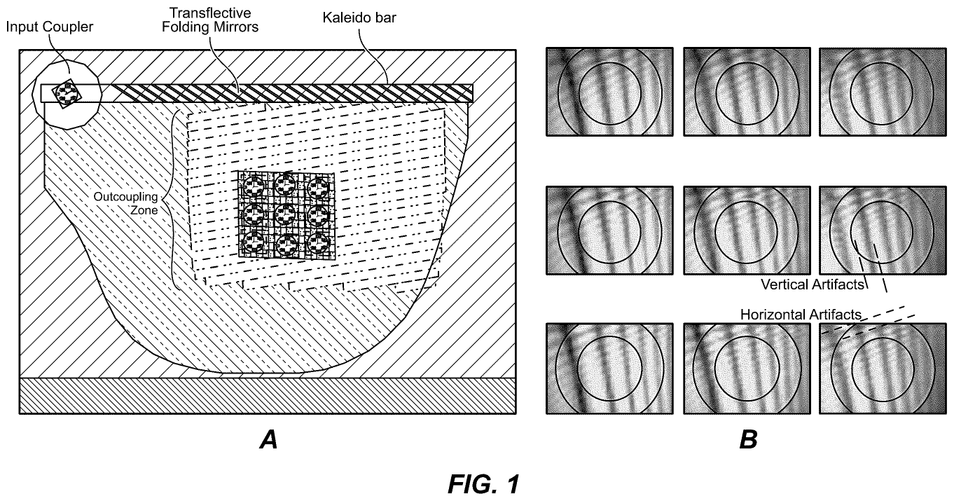

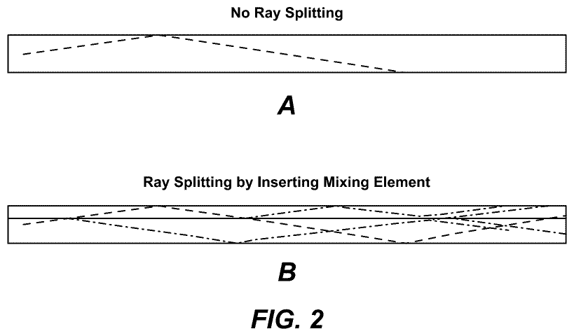

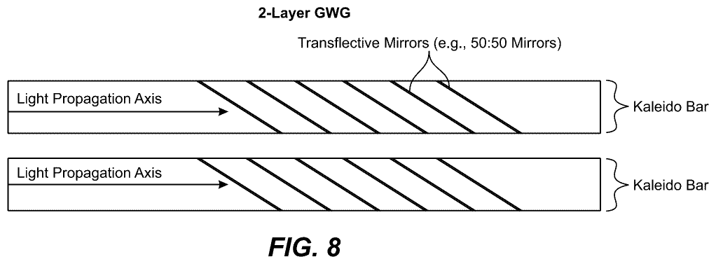

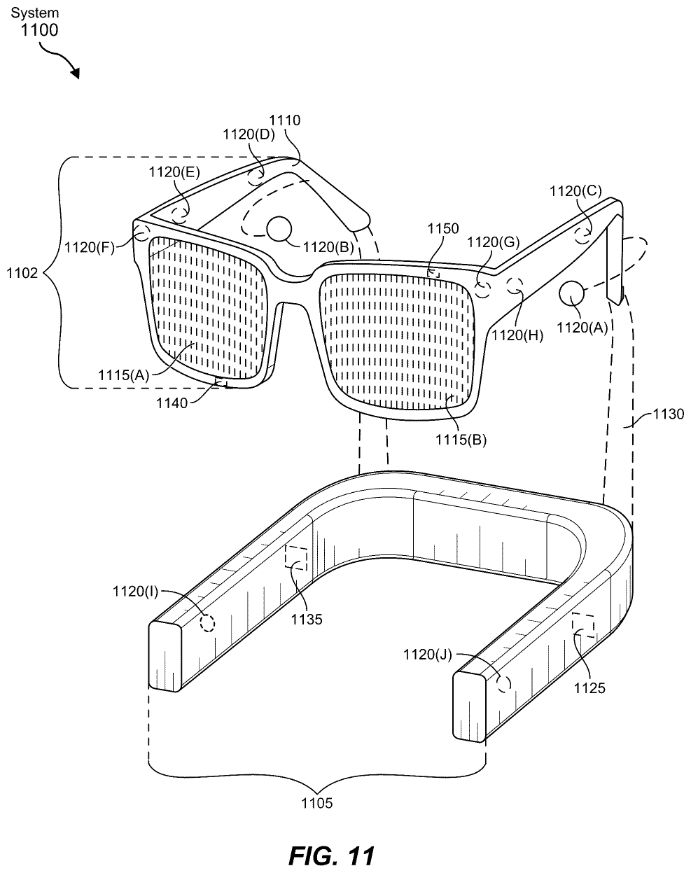

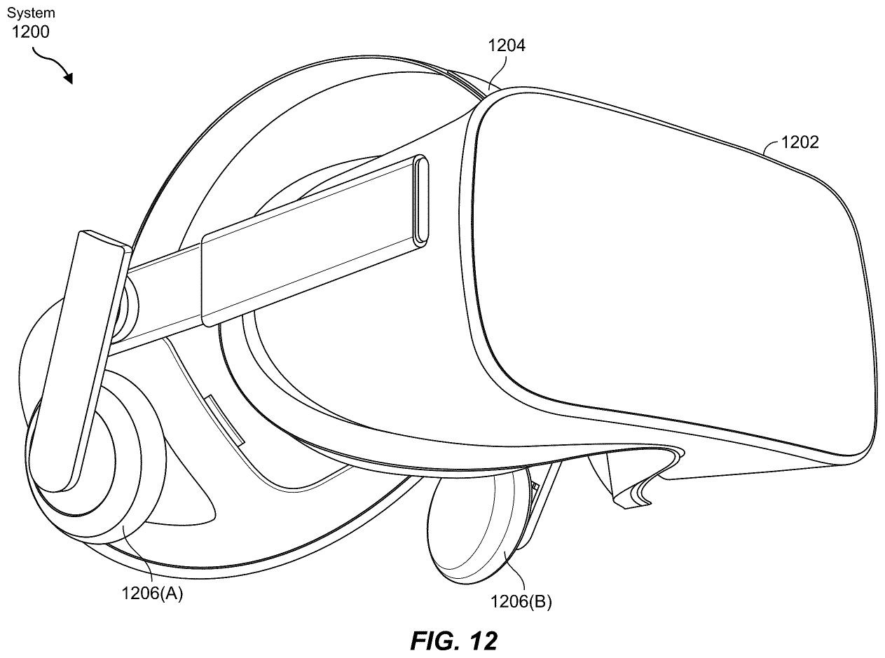

The following will provide, with reference to FIGS. 1-12, detailed descriptions of devices and related methods associated with layered geometric waveguides. The discussion associated with FIG. 1 includes a description of a geometric waveguide (GWG) and associated field of view intensity maps at nine eye pupil locations within the eyebox region. The discussion associated with FIGS. 2-7 includes a description of exemplary waveguide displays and the co-integration of one or more optical mixing elements within the waveguide. The discussion associated with FIGS. 8-10 includes a description of stacked (or layered) geometric waveguides and associated methods for their manufacture. The discussion associated with FIGS. 11 and 12 relates to exemplary virtual reality and augmented reality devices that may include one or more layered geometric waveguide displays as disclosed herein.

The configuration and performance of an example waveguide display are shown in FIG. 1. Referring initially to FIG. 1A, depicted is a front side view of the layout of a geometric waveguide. The waveguide includes a body (i.e., Kaleido bar) having an embedded array of folding mirrors. An input coupler (e.g., mirror or prism) is arranged to direct image light into the waveguide. The in-coupled light propagates down the waveguide by total internal reflection between opposing broadside surfaces and is refracted/expanded into the out-coupling zone by the array of folding mirrors. The out-coupling zone may include an array of output couplers that are configured to direct image light to the eye of a user.

A corresponding series of optical images (field-of-view intensity maps at nine eye pupil locations within the eyebox region) are shown in FIG. 1B. The images depict the nature of the optical artifacts generated by the geometric waveguide of FIG. 1A, including linear artifacts extending along horizontal and vertical directions. Without wishing to be bound by theory, the optical artifacts shown in FIG. 1B may derive from insufficient replication of image light. Further to the foregoing, Applicants have shown that the incorporation of one or more optical mixing elements into the Kaleido bar may be used to manipulate the propagating image light in a manner effective to increase the pupil replication density and decrease the observable optical artifacts.

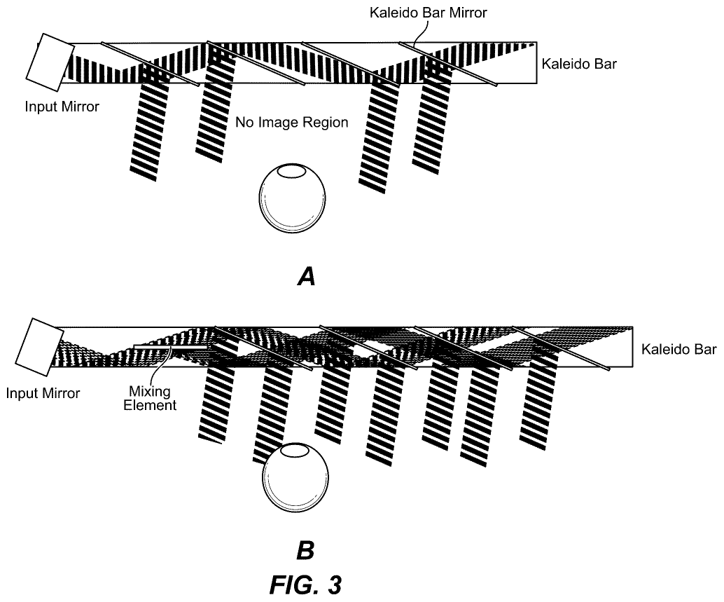

The effect of an optical mixing element on the replication of image light, including an improvement in the pupil replication density, is shown schematically in FIGS. 2 and 3. Referring to FIG. 2, an optical mixing element may extend along the entire length or substantially the entire length of the waveguide. As illustrated in FIG. 2A, without the addition of a mixing element, a light ray will propagate a relatively long distance between interactions with the waveguide. However, as shown in FIG. 2B, light ray splitting may be induced by the introduction of a mixing element within the waveguide.

Referring to FIG. 3, an optical mixing element may be segmented and positioned along only a portion of the length of the waveguide. It will be appreciated that an optical mixing element may split an incident beam of light without changing its propagation angle within the waveguide. In comparison to FIG. 3A, which illustrates the generation of a gap in the projected image, beam splitting induced by the added mixing element of FIG. 3B causes the projected light to fill the gap.

In some examples, an optical mixing element may be offset from a midline of the waveguide, as shown in FIG. 2, or located proximate to the waveguide's midline, as shown in FIG. 3B. That is, with particular reference to FIG. 2, an optical mixing element may be situated along a plane that is inscribed at a position corresponding to from approximately 55% to approximately 70% of the thickness of the waveguide body.

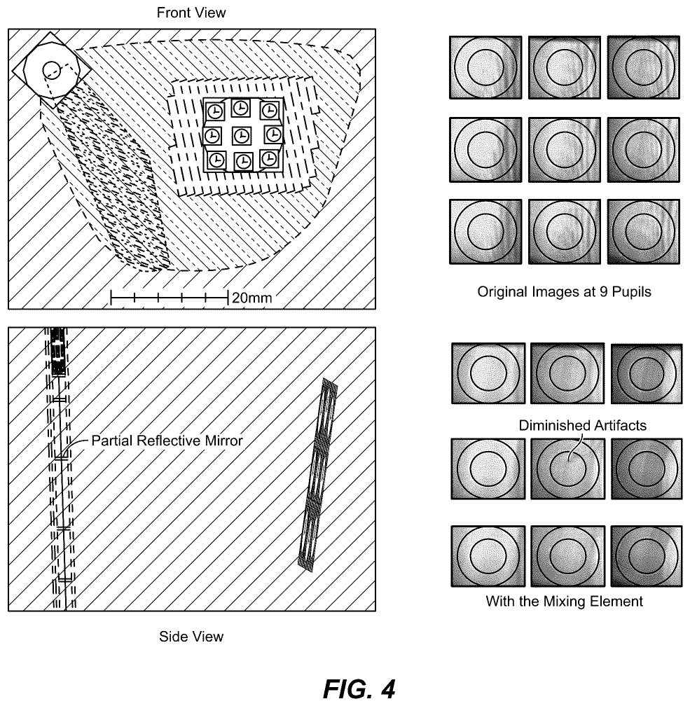

Referring to FIG. 4, shown is a further example waveguide display with an optical mixing element (transflective mirror) incorporated into the folding zone of the waveguide. Relative to a control waveguide display having no integrated optical mixing element, corresponding optical images demonstrate a marked improvement in the optical non-uniformity of the projected images with the addition of the transflective mirror.

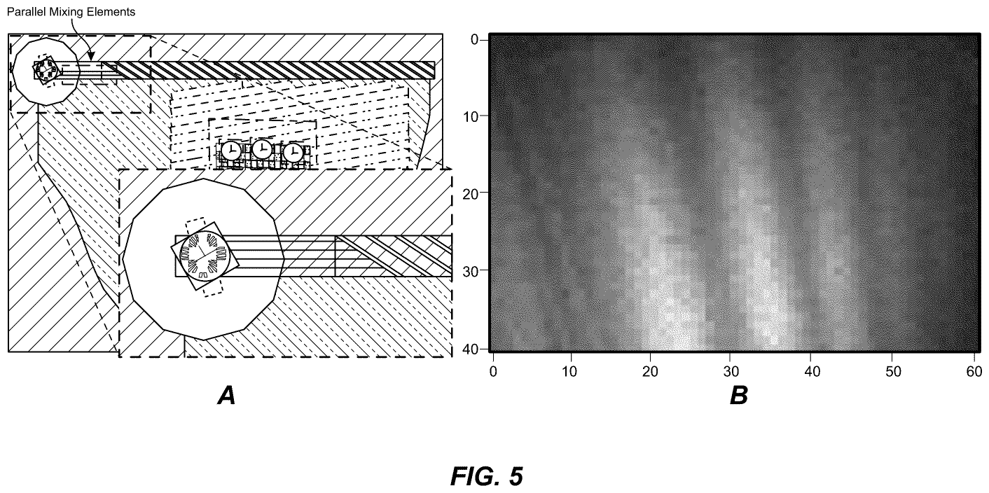

As will be appreciated with reference to FIGS. 5-7, various optical mixing element configurations may be used to improve pupil replication density and optical uniformity within a geometric waveguide. For example, an optical mixing element or an array of optical mixing elements may be oriented parallel and/or perpendicular to the light propagation axis of the waveguide and may accordingly be configured to interact with a selected polarization (e.g., TM mode or TE mode) of propagating image light.

Referring to FIG. 5, shown in FIG. 5A is an example waveguide display with three short horizontal mixing elements in the x-z plane and one short vertical mixing element in the x-y plane (transflective mirror) incorporated into the left side of the Kaleido bar. Relative to a control waveguide display having no integrated optical mixing element, a corresponding optical image in FIG. 5B demonstrates a marked improvement in the optical non-uniformity of the projected image with the addition of the transflective mirror.

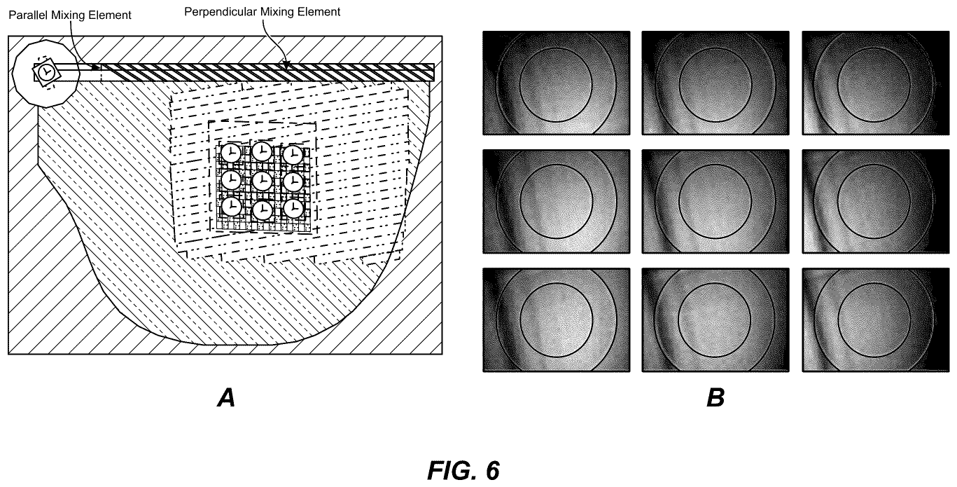

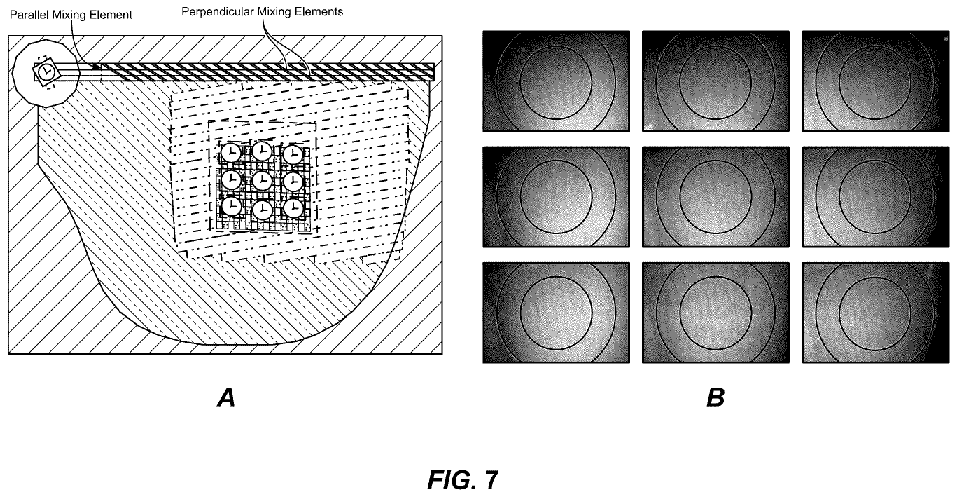

In FIGS. 6 and 7, a parallel optical mixing element may include one or more plates located in the x-y plane of the Kaleido bar, and a perpendicular optical mixing element may include one or more plates located in the x-z plane of the Kaleido bar.

Referring to FIG. 6A, shown is an example waveguide display with one long mixing element (throughout the WG) in the x-z plane and one long vertical mixing element (throughout the WG) in the x-y plane (transflective mirror) incorporated into the left side of the Kaleido bar. As shown in FIG. 6B, relative to a control waveguide display having no integrated optical mixing element, corresponding field of view intensity maps demonstrate a marked improvement in the optical non-uniformity of the projected images with the addition of the transflective mirrors.

Referring to FIG. 7A, shown is an example waveguide display with two long mixing elements (throughout the WG) in the x-z plane and one long vertical mixing element (throughout the WG) in the x-y plane (transflective mirror) incorporated into the left side of the Kaleido bar. As shown in FIG. 7B, relative to a control waveguide display having no integrated optical mixing element, corresponding field of view intensity maps demonstrate a marked improvement in the optical non-uniformity of the projected images with the addition of the transflective mirrors.

Disclosed also are layered geometric waveguides. Referring to FIG. 8, various layered architectures may be configured to improve the quality of a displayed image, and may provide additional advantages including greater pupil replication density, increased eyebox size and field of view, and improved efficiency and uniformity. A layered geometric waveguide may include a stack of two or more Kaleido bars or GWGs, for example.

In accordance with some embodiments, each waveguide layer (i.e., waveguide body) may be formed from any suitable optical material. Example waveguide materials include glasses (e.g., SiO₂ or SiON), electrooptic compositions (e.g., LiNbO₃), semiconductors (e.g., GaAs), and polymers (e.g., deuterated polymethylmethacrylate). Each of the several waveguides forming a layered GWG may be characterized by an equivalent, similar, or different material composition. Furthermore, example layered GWGs may include an air gap between adjacent waveguide layers. Moreover, various mirror configurations, including form factor, orientation, composition, reflectivity, etc. may be suitably defined both inter-layer and intra-layer within a layered geometric waveguide. For example, the orientation of one or more optical mixing elements within a Kaleido bar may be configured for a particular field of view.

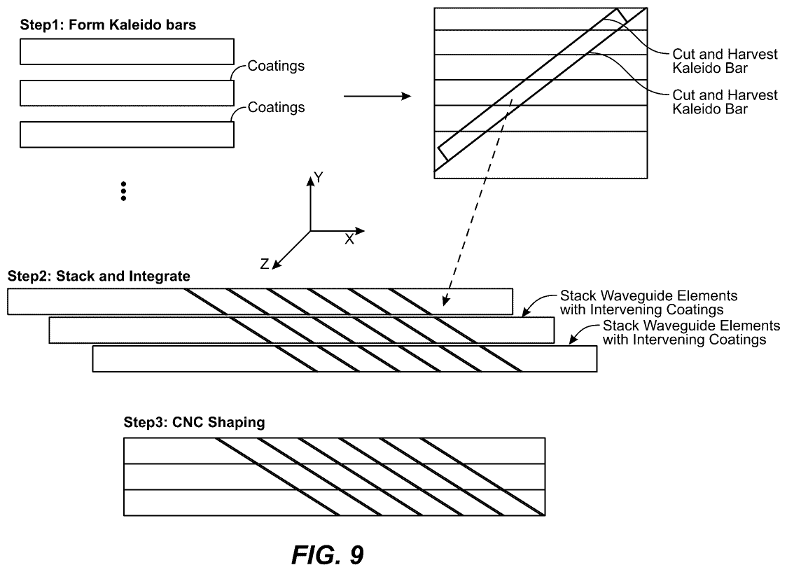

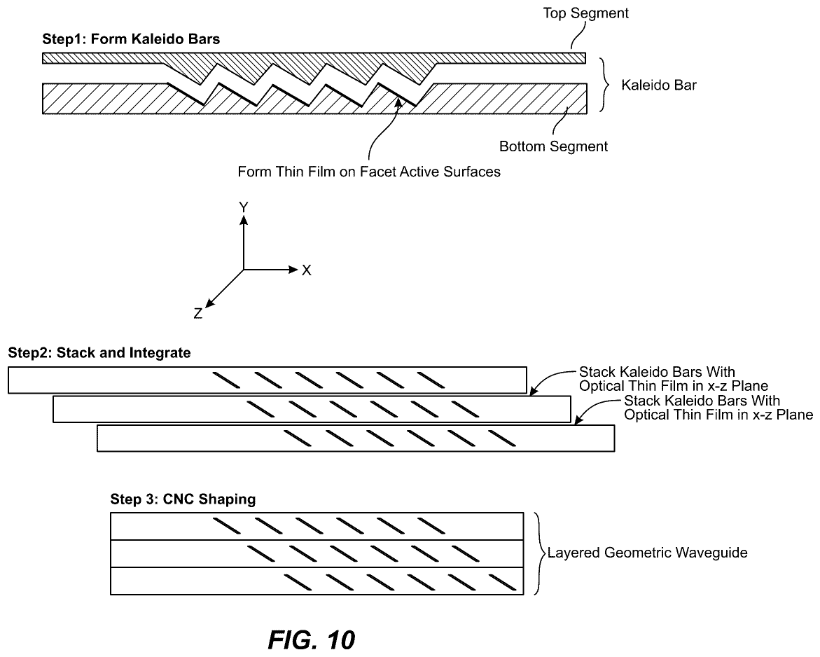

A variety of approaches may be used to manufacture a layered geometric waveguide. Exemplary methods are described with reference to FIG. 9 and FIG. 10. Referring to FIG. 9, a plurality of Kaleido bars or waveguides may be formed, aligned, stacked, and bonded to create a layered geometric waveguide. As shown in Step 1, coated glass or plastic substrates may laid up and bonded. The applied coatings may be configured to form folding mirrors. Individual Kaleido bars or waveguides may be harvested from the stack of coated substrates by orienting and cutting the stack. Turning to Step 2, the Kaleido bars or waveguides may be stacked and bonded, optionally with one or more intervening optical layers. A layered geometric waveguide may be formed having a desired form factor by dicing or milling, as illustrated in Step 3.

Referring now to FIG. 10, and initially to Step 1, top and bottom faceted substrate segments may be formed in a multi-step process by milling or directly by molding a suitable plastic, for example. Active surfaces of the various facets may be coated with an optical thin film. The thin film coatings may be configured to form WG mirrors. The coated substrate segments may be aligned and bonded to form individual Kaleido bars or waveguides. Plural Kaleido bars or waveguides may be stacked and bonded, optionally with one or more intervening optical layers, as shown in Step 2. The stack may be diced or milled to achieve a desired form factor, as shown in Step 3.

### EXAMPLE EMBODIMENTS

Example 1: A display system includes a waveguide body extending from an input end to an output end and configured to guide display light by total internal reflection from the input end to the output end between a top surface of the waveguide body and a bottom surface of the waveguide body, and an optical mixing element disposed within the waveguide body.

Example 2: The display system of Example 1, where the optical mixing element is configured to split a beam of the display light incident upon a surface of the optical mixing element.

Example 3: The display system of any of Examples 1 and 2, where the optical mixing element includes a transflective surface.

Example 4: The display system of any of Examples 1-3, where the optical mixing element has a substantially planar shape.

Example 5: The display system of any of Examples 1-4, where the optical mixing element extends from the input end toward the output end between the top and bottom surfaces.

Example 6: The display system of any of Examples 1-5, where the optical mixing element extends from the input end to the output end between the top and bottom surfaces.

Example 7: The display system of any of Examples 1-6, where the optical mixing element is disposed at a fixed distance from the input end and extends between the top surface and the bottom surface.

Example 8: The display system of any of Examples 1-7, further including a second optical mixing element disposed within the waveguide body, the second optical mixing element oriented parallel to the optical mixing element.

Example 9: The display system of any of Examples 1-7, further including a second optical mixing element disposed within the waveguide body, the second optical mixing element oriented perpendicular to the optical mixing element.

Example 10: The display system of any of Examples 1-9, further including a second optical mixing element disposed within the waveguide body, the second optical mixing element oriented parallel to the optical mixing element, and a third optical mixing element disposed within the waveguide body, the third optical mixing element oriented perpendicular to the optical mixing element.

Example 11: The display system of any of Examples 1-10, further including an input coupling element located proximate to the input end for coupling the display light into the waveguide body.

Example 12: The display system of any of Examples 1-11, further including an output coupling element located proximate to the output end for coupling the display light out of the waveguide body.

Example 13: A display system includes a waveguide body extending from an input end to an output end and configured to guide display light by total internal reflection from the input end to the output end, a first optical mixing element disposed within a first strata of the waveguide body, and a second optical mixing element disposed within a second strata of the waveguide body overlying the first strata.

Example 14: The display system of Example 13, where the first and second optical mixing elements each include a transflective surface.

Example 15: The display system of any of Examples 13 and 14, where the first and second optical mixing elements extend from the input end toward the output end between top and bottom surfaces of the waveguide body.

Example 16: The display system of any of Examples 13-15, further including a third optical mixing element disposed within the waveguide body, the third optical mixing element oriented perpendicular to the first and second optical mixing elements.

Example 17: A geometric waveguide includes a waveguide body extending from an input end to an output end and configured to guide display light by total internal reflection from the input end to the output end between a top surface of the waveguide body and a bottom surface of the waveguide body, an input coupling element located proximate to the input end for coupling the display light into the waveguide body, a first pupil expander having a plurality of transflective mirrors that are configured to deflect, at a first plurality of locations along a first direction, the display light toward a second pupil expander, and an optical mixing element disposed within the waveguide body, where the optical mixing element is configured to split a beam of the display light incident upon a surface of the mixing element.

Example 18: The geometric waveguide of Example 17, where the plurality of transflective mirrors are inclined with respect to a broadside surface of the waveguide body.

Example 19: The geometric waveguide of any of Examples 17 and 18, where the optical mixing element extends from the input end toward the output end and parallel to a broadside surface of the waveguide body.

Example 20: The geometric waveguide of any of Examples 17-19, where the optical mixing element is disposed at a fixed distance from the input end and extends between the top surface and the bottom surface.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 1100 in FIG. 11) or that visually immerses a user in an artificial reality (e.g., virtual-reality system 1200 in FIG. 12). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 11, augmented reality system 1100 may include an eyewear device 1102 with a frame 1110 configured to hold a left display device 1115(A) and a right display device 1115(B) in front of a user's eyes. Display devices 1115(A) and 1115(B) may act together or independently to present an image or series of images to a user. While augmented-reality system 1100 includes two displays, embodiments of this disclosure may be implemented in augmented-reality systems with a single NED or more than two NEDs.

In some embodiments, augmented-reality system 1100 may include one or more sensors, such as sensor 1140. Sensor 1140 may generate measurement signals in response to motion of augmented-reality system 1100 and may be located on substantially any portion of frame 1110. Sensor 1140 may represent a position sensor, an inertial measurement unit (IMU), a depth camera assembly, a structured light emitter and/or detector, or any combination thereof. In some embodiments, augmented-reality system 1100 may or may not include sensor 1140 or may include more than one sensor. In embodiments in which sensor 1140 includes an IMU, the IMU may generate calibration data based on measurement signals from sensor 1140. Examples of sensor 1140 may include, without limitation, accelerometers, gyroscopes, magnetometers, other suitable types of sensors that detect motion, sensors used for error correction of the IMU, or some combination thereof.

Augmented-reality system 1100 may also include a microphone array with a plurality of acoustic transducers 1120(A)-1120(J), referred to collectively as acoustic transducers 1120. Acoustic transducers 1120 may be transducers that detect air pressure variations induced by sound waves. Each acoustic transducer 1120 may be configured to detect sound and convert the detected sound into an electronic format (e.g., an analog or digital format). The microphone array in FIG. 11 may include, for example, ten acoustic transducers: 1120(A) and 1120(B), which may be designed to be placed inside a corresponding ear of the user, acoustic transducers 1120(C), 1120(D), 1120(E), 1120(F), 1120(G), and 1120(H), which may be positioned at various locations on frame 1110, and/or acoustic transducers 1120(I) and 1120(J), which may be positioned on a corresponding neckband 1105.

In some embodiments, one or more of acoustic transducers 1120(A)-(F) may be used as output transducers (e.g., speakers). For example, acoustic transducers 1120(A) and/or 1120(B) may be earbuds or any other suitable type of headphone or speaker.

The configuration of acoustic transducers 1120 of the microphone array may vary. While augmented-reality system 1100 is shown in FIG. 11 as having ten acoustic transducers 1120, the number of acoustic transducers 1120 may be greater or less than ten. In some embodiments, using higher numbers of acoustic transducers 1120 may increase the amount of audio information collected and/or the sensitivity and accuracy of the audio information. In contrast, using a lower number of acoustic transducers 1120 may decrease the computing power required by an associated controller 1150 to process the collected audio information. In addition, the position of each acoustic transducer 1120 of the microphone array may vary. For example, the position of an acoustic transducer 1120 may include a defined position on the user, a defined coordinate on frame 1110, an orientation associated with each acoustic transducer 1120, or some combination thereof.

Acoustic transducers 1120(A) and 1120(B) may be positioned on different parts of the user's ear, such as behind the pinna, behind the tragus, and/or within the auricle or fossa. Or, there may be additional acoustic transducers 1120 on or surrounding the ear in addition to acoustic transducers 1120 inside the ear canal. Having an acoustic transducer 1120 positioned next to an ear canal of a user may enable the microphone array to collect information on how sounds arrive at the ear canal. By positioning at least two of acoustic transducers 1120 on either side of a user's head (e.g., as binaural microphones), augmented-reality device 1100 may simulate binaural hearing and capture a 3D stereo sound field around about a user's head. In some embodiments, acoustic transducers 1120(A) and 1120(B) may be connected to augmented-reality system 1100 via a wired connection 1130, and in other embodiments acoustic transducers 1120(A) and 1120(B) may be connected to augmented-reality system 1100 via a wireless connection (e.g., a Bluetooth connection). In still other embodiments, acoustic transducers 1120(A) and 1120(B) may not be used at all in conjunction with augmented-reality system 1100.

Acoustic transducers 1120 on frame 1110 may be positioned along the length of the temples, across the bridge, above or below display devices 1115(A) and 1115(B), or some combination thereof. Acoustic transducers 1120 may be oriented such that the microphone array is able to detect sounds in a wide range of directions surrounding the user wearing the augmented-reality system 1100. In some embodiments, an optimization process may be performed during manufacturing of augmented-reality system 1100 to determine relative positioning of each acoustic transducer 1120 in the microphone array.

In some examples, augmented-reality system 1100 may include or be connected to an external device (e.g., a paired device), such as neckband 1105. Neckband 1105 generally represents any type or form of paired device. Thus, the following discussion of neckband 1105 may also apply to various other paired devices, such as charging cases, smart watches, smart phones, wrist bands, other wearable devices, hand-held controllers, tablet computers, laptop computers, other external compute devices, etc.

As shown, neckband 1105 may be coupled to eyewear device 1102 via one or more connectors. The connectors may be wired or wireless and may include electrical and/or non-electrical (e.g., structural) components. In some cases, eyewear device 1102 and neckband 1105 may operate independently without any wired or wireless connection between them. While FIG. 11 illustrates the components of eyewear device 1102 and neckband 1105 in example locations on eyewear device 1102 and neckband 1105, the components may be located elsewhere and/or distributed differently on eyewear device 1102 and/or neckband 1105. In some embodiments, the components of eyewear device 1102 and neckband 1105 may be located on one or more additional peripheral devices paired with eyewear device 1102, neckband 1105, or some combination thereof.

Pairing external devices, such as neckband 1105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1100 may be provided by a paired device or shared between a paired device and an eyewear device, thus reducing the weight, heat profile, and form factor of the eyewear device overall while still retaining desired functionality. For example, neckband 1105 may allow components that would otherwise be included on an eyewear device to be included in neckband 1105 since users may tolerate a heavier weight load on their shoulders than they would tolerate on their heads. Neckband 1105 may also have a larger surface area over which to diffuse and disperse heat to the ambient environment. Thus, neckband 1105 may allow for greater battery and computation capacity than might otherwise have been possible on a stand-alone eyewear device. Since weight carried in neckband 1105 may be less invasive to a user than weight carried in eyewear device 1102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1105 may be communicatively coupled with eyewear device 1102 and/or to other devices. These other devices may provide certain functions (e.g., tracking, localizing, depth mapping, processing, storage, etc.) to augmented-reality system 1100. In the embodiment of FIG. 11, neckband 1105 may include two acoustic transducers (e.g., 1120(I) and 1120(J)) that are part of the microphone array (or potentially form their own microphone subarray). Neckband 1105 may also include a controller 1125 and a power source 1135.

Acoustic transducers 1120(I) and 1120(J) of neckband 1105 may be configured to detect sound and convert the detected sound into an electronic format (analog or digital). In the embodiment of FIG. 11, acoustic transducers 1120(I) and 1120(J) may be positioned on neckband 1105, thereby increasing the distance between the neckband acoustic transducers 1120(I) and 1120(J) and other acoustic transducers 1120 positioned on eyewear device 1102. In some cases, increasing the distance between acoustic transducers 1120 of the microphone array may improve the accuracy of beamforming performed via the microphone array. For example, if a sound is detected by acoustic transducers 1120(C) and 1120(D) and the distance between acoustic transducers 1120(C) and 1120(D) is greater than, e.g., the distance between acoustic transducers 1120(D) and 1120(E), the determined source location of the detected sound may be more accurate than if the sound had been detected by acoustic transducers 1120(D) and 1120(E).

Controller 1125 of neckband 1105 may process information generated by the sensors on neckband 1105 and/or augmented-reality system 1100. For example, controller 1125 may process information from the microphone array that describes sounds detected by the microphone array. For each detected sound, controller 1125 may perform a direction-of-arrival (DOA) estimation to estimate a direction from which the detected sound arrived at the microphone array. As the microphone array detects sounds, controller 1125 may populate an audio data set with the information. In embodiments in which augmented-reality system 1100 includes an inertial measurement unit, controller 1125 may compute all inertial and spatial calculations from the IMU located on eyewear device 1102. A connector may convey information between augmented-reality system 1100 and neckband 1105 and between augmented-reality system 1100 and controller 1125. The information may be in the form of optical data, electrical data, wireless data, or any other transmittable data form. Moving the processing of information generated by augmented-reality system 1100 to neckband 1105 may reduce weight and heat in eyewear device 1102, making it more comfortable to the user.

Power source 1135 in neckband 1105 may provide power to eyewear device 1102 and/or to neckband 1105. Power source 1135 may include, without limitation, lithium ion batteries, lithium-polymer batteries, primary lithium batteries, alkaline batteries, or any other form of power storage. In some cases, power source 1135 may be a wired power source. Including power source 1135 on neckband 1105 instead of on eyewear device 1102 may help better distribute the weight and heat generated by power source 1135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1200 in FIG. 12, that mostly or completely covers a user's field of view. Virtual-reality system 1200 may include a front rigid body 1202 and a band 1204 shaped to fit around a user's head. Virtual-reality system 1200 may also include output audio transducers 1206(A) and 1206(B). Furthermore, while not shown in FIG. 12, front rigid body 1202 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 1100 and/or virtual-reality system 1200 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 1100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 1100 and/or virtual-reality system 1200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 12, output audio transducers 1206(A) and 1206(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 11, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a dielectric waveguide that comprises or includes lithium niobate include embodiments where a dielectric waveguide consists essentially of lithium niobate and embodiments where a dielectric waveguide consists of lithium niobate.

What is claimed is:

1. A display system comprising:
a waveguide body extending from an input end to an output end and configured to guide display light by total internal reflection from the input end to the output end between a top surface of the waveguide body and a bottom surface of the waveguide body; and
an optical mixing element disposed within the waveguide body.

2. The display system of claim 1, wherein the optical mixing element is configured to split a beam of the display light incident upon a surface of the optical mixing element.

3. The display system of claim 1, wherein the optical mixing element comprises a transflective surface.

4. The display system of claim 1, wherein the optical mixing element comprises a substantially planar shape.

5. The display system of claim 1, wherein the optical mixing element extends from the input end toward the output end between the top and bottom surfaces.

6. The display system of claim 1, wherein the optical mixing element extends from the input end to the output end between the top and bottom surfaces.

7. The display system of claim 1, wherein the optical mixing element is disposed at a fixed distance from the input end and extends between the top surface and the bottom surface.

8. The display system of claim 1, further comprising a second optical mixing element disposed within the waveguide body, the second optical mixing element oriented parallel to the optical mixing element.

9. The display system of claim 1, further comprising a second optical mixing element disposed within the waveguide body, the second optical mixing element oriented perpendicular to the optical mixing element.

10. The display system of claim 1, further comprising:
a second optical mixing element disposed within the waveguide body, the second optical mixing element oriented parallel to the optical mixing element; and
a third optical mixing element disposed within the waveguide body, the third optical mixing element oriented perpendicular to the optical mixing element.

11. The display system of claim 1, further comprising an input coupling element located proximate to the input end for coupling the display light into the waveguide body.

12. The display system of claim 1, further comprising an output coupling element located proximate to the output end for coupling the display light out of the waveguide body.

13. A display system comprising:
a waveguide body extending from an input end to an output end and configured to guide display light by total internal reflection from the input end to the output end;
a first optical mixing element disposed within a first strata of the waveguide body; and
a second optical mixing element disposed within a second strata of the waveguide body overlying the first strata.

14. The display system of claim 13, wherein the first and second optical mixing elements each comprise a transflective surface.

15. The display system of claim 13, wherein the first and second optical mixing elements extend from the input end toward the output end between top and bottom surfaces of the waveguide body.

16. The display element of claim 13, further comprising a third optical mixing element disposed within the waveguide body, the third optical mixing element oriented perpendicular to the first and second optical mixing elements.

17. A geometric waveguide comprising:
a waveguide body extending from an input end to an output end and configured to guide display light by total internal reflection from the input end to the output end between a top surface of the waveguide body and a bottom surface of the waveguide body;
an input coupling element located proximate to the input end for coupling the display light into the waveguide body;
a first pupil expander comprising a plurality of transflective mirrors that are configured to deflect, at a first plurality of locations along a first direction, the display light toward a second pupil expander; and
an optical mixing element disposed within the waveguide body, wherein the optical mixing element is configured to split a beam of the display light incident upon a surface of the mixing element.

18. The geometric waveguide of claim 17, wherein the plurality of transflective mirrors are inclined with respect to a broadside surface of the waveguide body.

19. The geometric waveguide of claim 17, wherein the optical mixing element extends from the input end toward the output end and parallel to a broadside surface of the waveguide body.

20. The geometric waveguide of claim 17, wherein the optical mixing element is disposed at a fixed distance from the input end and extends between the top surface and the bottom surface.
